(19) United States
(12) Patent Application Publication
(10) Pub. No.: US 2025/0387001 A1
(43) Pub. Date: Dec. 25, 2025

(54) Grit Tip Handle Scrub

(71) Applicant: Joshua Bourque, Atkinson, NH (US)

(72) Inventor: Joshua Bourque, Atkinson, NH (US)

(21) Appl. No.: 18/748,408

(22) Filed: Jun. 20, 2024

(51) Int. Cl. A47L 17/08; A47L 17/06; B25G 1/04; B25G 3/30

(52) U.S. Cl. CPC A47L 17/08; A47L 17/06; B25G 1/04; B25G 3/30

(57) ABSTRACT

A cleaning applicator has a bulb in the shape of an oval and a stem at one end and a handle end configured to receive the bulb stem and a skin made to fit the bulb and embedded with a cleaning abrasive. A padding fits the bulb underneath the skin to help in cleaning and scouring with the tip of the cleaning applicator. The bulb oval shape is elliptical and it can be egg-like with the stem at the larger end of the egg-like oval. The stem is threaded and the handle has a complementary thread to receive the stem. The handle comprises polypropylene and the bulb can include polypropylene.

### SUMMARY OF THE INVENTION

A cleaning applicator has a bulb in the shape of an oval and a stem at one end and a handle end configured to receive the bulb stem and a skin made to fit the bulb and embedded with a cleaning abrasive. A padding fits the bulb underneath the skin to help in cleaning and scouring with the tip of the cleaning applicator. The bulb oval shape is elliptical and it can be egg-like with the stem at the larger end of the egg-like oval. The stem is threaded and the handle has a complementary thread to receive the stem. The handle comprises polypropylene and the bulb can include polypropylene.

### BRIEF DESCRIPTION OF THE DRAWINGS

FIG. 1 is an assembled view of the grit tip handle scrub in accordance with an embodiment of the present disclosure.

FIG. 2 is an assembled view of the grit tip handle scrub with embedded abrasives and an extended handle in accordance with an embodiment of the present disclosure.

FIG. 3 is a partial closeup and sectional view of the grit tip handle scrub showing the embedded cleaning studs in accordance with an embodiment of the present disclosure.

FIG. 4 is a partial exploded view of the grit tip handle scrub in accordance with an embodiment of the present disclosure.

FIG. 5 is a view of the abrasive embedded skin in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

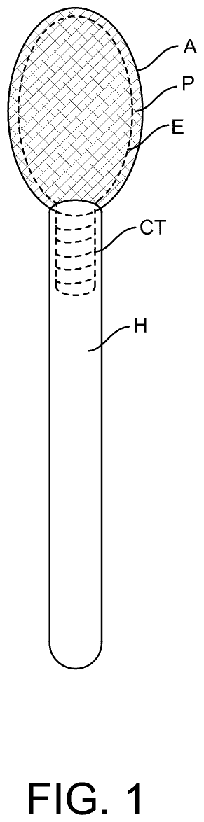

FIG. 1 is an assembled view of the grit tip handle scrub in accordance with an embodiment of the present disclosure. The view includes the abrasive embedded skin A, the bulb E, the complementary threads CT, the pad P between the abrasive embedded skin A and the bulb E and the handle H.

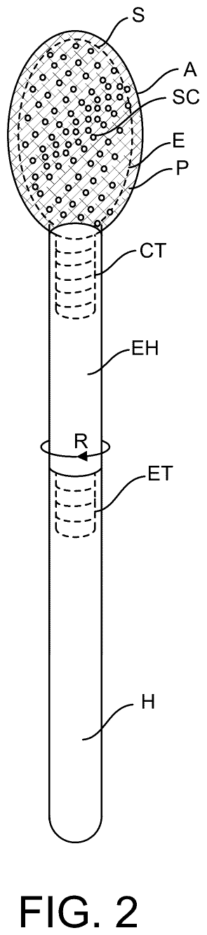

FIG. 2 is an assembled view of the grit tip handle scrub with embedded abrasives and an extended handle in accordance with an embodiment of the present disclosure. The view includes the limitations of FIG. 1 and additionally the abrasive studs S, the portion of concentrated studs SC, and the extension threads ET for the extension handle EH. The clockwise arrow R indicates a direction of tightening the extension handle EH onto the handle H.

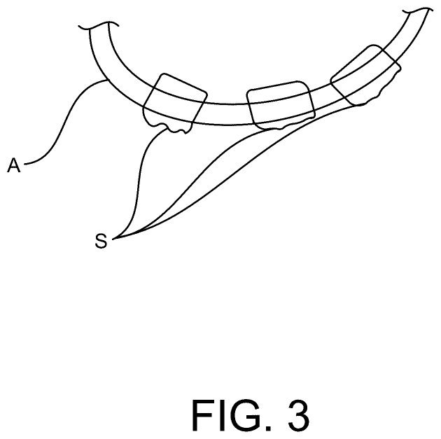

FIG. 3 is a partial closeup and sectional view of the grit tip handle scrub showing the embedded cleaning studs in accordance with an embodiment of the present disclosure. The view shows the studs penetrating through the abrasive embedded skin A against the bulb E. Other abrasives are embedded in the skin A but do not penetrate there through as indicated by the cross hatching shading in FIG. 1 and in FIG. 2.

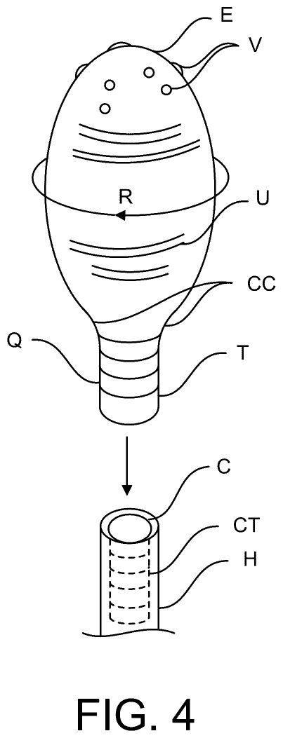

FIG. 4 is a partial exploded view of the grit tip handle scrub in accordance with an embodiment of the present disclosure. The view shows limitations of all previous figures and additionally shows the chamfered transition CC from the bulb to the stem with helical threads T. The chamfer C on the receiving end of the handle H or in an extension handle EH matches with the chamfer CC of the bulb E and the stem.

A cleaning applicator has a bulb E in the shape of an oval and a stem at one end and a handle H comprising an end configured to receive the bulb stem Q and a skin A configured to fit the bulb E and embedded with a cleaning abrasive.

Embodiments of the disclosure include a padding P configured to fit the bulb E underneath the skin A to help in cleaning and scouring with the tip of the cleaning applicator. The bulb oval shape is elliptical and it can be egg-like with the stem at the larger end of the egg-like oval. The stem Q is threaded and the handle comprises a complementary thread CT to receive the stem. The handle H comprises polypropylene and the bulb E can include polypropylene.

Other embodiments include the skin embedded with abrasive fibers configured to clean stainless steel cooking surface. The skin A is embedded with grit particles configured to scrub and scour a stainless steel cooking surface. A portion of the skin A covering a tip of the bulb E is embedded with small particles configured too scrub and scour. Other portions of the skin A are embedded with studs S configured to scrap and to clean hardened organic compounds from cooking. An extension handle EH configured with a male end and a female end and complementary threads CT to the bulb stem Q.

The view includes the protuberances V on a portion of a surface of the bulb E and concentric undulations U on other portions of the surface of the bulb E. The stem Q includes helical threads T which as indicated by the motion arrow R in a clockwise rotation will fasten the bulb E to the handle H.

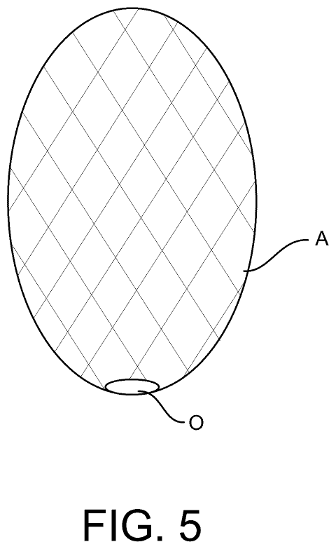

FIG. 5 is a view of the abrasive embedded skin in accordance with an embodiment of the present disclosure. The view shows the orifice O opening the elastic skin to slide over the bulb E. The skin defines an elastic opening configured to slide over the bulb and lodge between a chamfered end of the handle and a chamfer transition of the stem to the bulb.

The Scouring Pad Tipped Applicator is originally conceived for the housewares/hardware industry. The Scouring Pad Tipped Applicator consists of the following two (2) separate items: 1. Scouring tip (embedded abrasive material) 2. Polypropylene handle comes in different sizes 3″, 6″, 9″, 12″ The main purpose of the Scouring Pad Tipped Applicator is to provide users with a cleaning tool possessing an abrasive tip designed to scrub hard-to-reach areas. Threads, sealing surfaces, and inaccessible areas are often overlooked by traditional cleaning tools, making it more challenging, tedious, and time-consuming to clean hard to-reach places when tackling cleaning in laboratories, kitchens, mechanic shops, and/or at home.

This leaves a great opportunity for an improved accessory that can meet the need of cleaning challenging surfaces. Ingenious and practical, the Scouring Pad Tipped Applicator offers a modern accessory that ensures users can clean hard-to access places that conventional cotton-tipped applicators or scouring pads cannot effectively address. Expanding on the initial design of an average scouring pad, the Scouring Pad Tipped Applicator introduces a novel abrasive tip embedded with an abrasive material that surpasses traditional cleaning methods. It is specifically engineered to remove stubborn residues and contaminants on surfaces like stainless steel and glass, where regular wipes or rags would fall short.

The abrasive material ensures a thorough and precise cleaning experience. Moreover, the polypropylene handle offers superior chemical resistance, guaranteeing the cleaning tool remains in pristine condition in the presence of harsh solvents; thus, ensuring long-lasting performance. This innovative, top-quality product can be used in chemical facilities and laboratories, and used to clean rooms in various environments. As a result, the Scouring Pad Tipped Applicator may prove to be essential in the housewares/hardware industry.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A cleaning applicator, comprising:
a bulb having a shape of an oval and a stem at one end;
a handle comprising an end configured to receive the bulb stem; and
a skin configured to fit the bulb and embedded with a cleaning abrasive.

2. The cleaning applicator of claim 1, further comprising a padding configured to fit the bulb underneath the skin.

3. The cleaning applicator of claim 1, wherein the bulb oval shape is elliptical.

4. The cleaning applicator of claim 1, wherein the bulb oval shape is egg-like and the stem is at the larger end of the egg-like oval.

5. The cleaning applicator of claim 1, wherein the stem is threaded and the handle comprises a complementary thread to receive the stem.

6. The cleaning applicator of claim 1, wherein the handle comprises polypropylene.

7. The cleaning applicator of claim 1, wherein the bulb comprises polypropylene.

8. The cleaning applicator of claim 1, wherein the skin is embedded with abrasive fibers configured to clean stainless steel cooking surface.

9. The cleaning applicator of claim 1, wherein the skin is embedded with grit particles configured to scrub and scour a stainless steel cooking surface.

10. The cleaning applicator of claim 1, wherein a portion of the skin covering a tip of the bulb is embedded with small particles configured too scrub and scour.

11. The cleaning applicator of claim 1, wherein a portion of the skin is embedded with studs configured to scrap and to clean hardened organic compounds from cooking.

12. The cleaning applicator of claim 1, further comprising an extension handle configured with a male end and a female end and complementary threads to the bulb stem.

13. The cleaning applicator of claim 12, wherein a surface of the bulb comprises protuberances.

14. The cleaning applicator of claim 1, wherein a surface of the bulb comprises concentric undulations.

15. The fishing pole of claim 1, wherein the skin defines an elastic opening configured to slide over the bulb and lodge between a chamfered end of the handle and a chamfer transition of the stem to the bulb.
